(19) United States
(12) Patent Application Publication
(10) Pub. No.: US 2021/0347128 A1
(43) Pub. Date: Nov. 11, 2021

(54) TOOL FOR APPLYING A FILM

(71) Applicants: PROFOL GMBH, Halfing (DE); SI SILICONE INNOVATION GMBH, Wangen im Allgäu (DE)

(72) Inventors: Christian HÜBNER, Halfing (DE); Johannes KÖRNER, Halfing (DE)

(21) Appl. No.: 17/277,696

(22) PCT Filed: Sep. 19, 2019
(86) PCT No.: PCT/EP2019/075163

§ 371 Date: Mar. 18, 2021

(30) Foreign Application Priority Data
Sep. 19, 2018 (DE) 10 2018 215 939.4

(51) Int. Cl. B29C 65/00

(52) U.S. Cl. CPC B29C 66/2422; B29C 66/112; B29L 2031/712; B29C 66/53461; B29C 66/8122; B29C 66/4312

(57) ABSTRACT

Tool (1) for applying a film onto a target object under the action of heat and/or pressure, comprising a support (11) of a first material and a bar (21) of a second, elastic material, wherein the bar is arranged on the support, and wherein the bar has at least one area (W) that is curved outwards.

### TECHNICAL FIELD

The present invention relates to a tool for applying a film onto a target object. The tool can be used to apply a film onto the target object under the action of heat and/or pressure. In one preferred embodiment, the tool is used to seal packaging for food.

### TECHNICAL BACKGROUND

In the field of packaging of, for example, food, the object is often to seal a target object in the form of a receptacle (for example, pot, bucket, barrel, etc.). It is known to provide such receptacles as a target object with a rim along the opening and to apply onto this rim a lid made of a film for sealing. The lid can be made of various materials and can also be applied using various methods. Methods that are on offer include, inter alia, bonding, pressing and welding. The selected materials and methods can then each provide certain advantages, but often also suffer from corresponding disadvantages, and therefore the selection of materials and methods for a particular intended use and purpose is often limited.

More recently, additional challenges have also arisen, in particular in the packaging of consumer goods (food, medicaments, cosmetics, consumables, etc.): For example, a specific varietal purity of the packaging as a whole is often necessary for sufficient recyclability. It is often required in this regard that both the receptacle (i.e. the target object in the form of, for example, a pot) and the seal (lid) are made of a sufficiently similar or even the same material so that easy recycling is possible for disposal. Nevertheless, other factors must be taken into account, in particular in the consumer goods sector. Good printability of the materials, compliance with hygiene regulations, and a satisfactory opening experience by the user should be mentioned at this point. The latter is particularly important for food products since the user, i.e. the consumer, should be given a safe feeling that, firstly, the receptacle was reliably closed before opening and, secondly, that the receptacle does not show any damage after opening and also that the seal was satisfactorily opened. This can relate to a complete removal of the lid and/or good resealability.

With regard to compliance with hygiene standards and regulations, it should be mentioned that as a result of filling and sealing of a food packaging, neither the outside of the packaging should be contaminated with the content (i.e. the food) nor the tools and equipment used for packaging should be contaminated with the content or goods to be filled. For example, residues outside the packaging not only leave an unclean impression but can also spoil and/or contaminate other goods. Contamination of the filling plant (including tool(s), holders, transport mechanisms, etc.) itself is also often undesirable, particularly if the goods to be filled are perishable food.

There is therefore a need for a technology to achieve the above objectives in the application of a film, particularly in connection with a packaging of goods to be filled. Consideration should also be given to economic efficiency, reliability and an overall satisfactory compliance with all applicable standards. It is therefore a particular object of the present invention to provide a tool for applying a film with which one or more of the aforementioned objectives can be achieved.

### SUMMARY

The aforementioned problems and objects are solved by the subject matters of the independent patent claims. Further advantageous embodiments of the present invention are given in the dependent patent claims.

According to one embodiment of the present invention, there is provided a tool for applying a film onto a target object under the action of heat and/or pressure, comprising a support of a first material and a bar of a second, elastic material, wherein the bar is arranged on the support, and wherein the bar has at least one area (W) that is curved outwards.

According to one embodiment of the present invention, a method is provided of applying a film onto a target object under the action of heat and/or pressure, comprising the steps of providing a tool comprising a support of a first material and a bar of a second, elastic material, wherein the bar is arranged on the support, and wherein the bar has at least one area that is curved outwards, of placing the target object in a holder, of providing and arranging the film between the target object and the tool, of achieving a target temperature on the bar of the tool, and of controlled approaching and pressing the tool onto at least one part of the target object so that the film is joined at least to this part.

### BRIEF DESCRIPTION OF THE FIGURES

The embodiments of the present invention will be explained and illustrated in particular in connection with the following figures. The scope of protection should not be limited to this embodiment, and the figures and the corresponding description thus only serve to illustrate the general inventive concept. The enclosed figures show:

FIGS. 1A and 1B a schematic sectional view or top view of a tool according to a first embodiment of the present invention;

FIGS. 2A to 2D schematic sectional views of tools according to further embodiments of the present invention;

FIGS. 3A to 3E schematic sectional views of tools according to further embodiments of the present invention,

FIGS. 4A to 4D schematic top views of possible courses of bars in tools according to further embodiments of the present invention,

FIG. 5 schematically a use of the tool in applying a film onto a target object according to one embodiment of the present invention, and

FIG. 6 schematically a flow chart of a method embodiment of the present invention.

### DETAILED DESCRIPTION

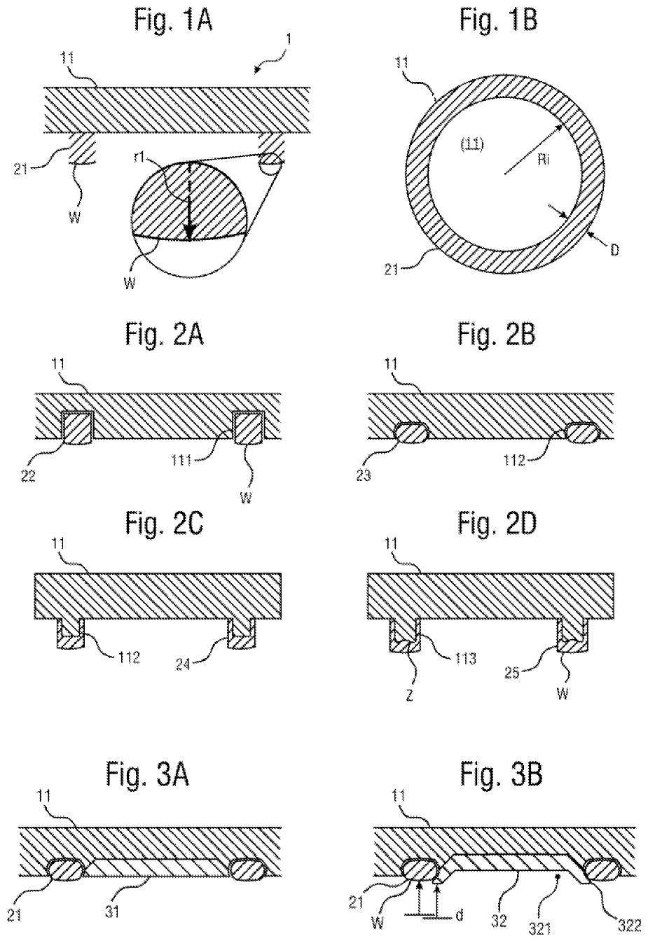

FIG. 1A shows a schematic sectional view of a tool according to a first embodiment of the present invention. A tool 1 is used to apply a film onto a target object under the action of heat and/or pressure. The tool 1 comprises a support 11 made of a first material and a bar 21 made of a second, elastic material, wherein the bar 21 is arranged on the support 11 and has at least one area W that is curved outwards. A section of this curved portion is further shown enlarged. This can reveal a circular or elliptical basic shape which can be described by one or more radii. In advantageous embodiments of the invention, the curvature W can follow a circle with a radius r1 in a range from 4 mm to 9 mm.

The first material of the support 11 is preferably a metal such as aluminum, copper, an aluminum alloy, a copper alloy, brass, bronze, Amcorloy, or steel. In embodiments where the tool is used to apply a film onto a target object under the action of heat, the first material should have sufficient or the desired heat conductivity or heat capacity. If welding, i.e. at least a partial melting of the film and, if necessary, parts of the target object, is desired, sufficient heat conduction is required to conduct the necessary melting heat within the desired time from a heater or heat source (not shown) to the curved area of the bar.

The second material of the bar is preferably a high temperature resistant silicone or another elastomer of Shore A hardness between 50 and 80. In particular, material resistance can be up to temperatures of, for example, 250° C. and above. The second material can further comprise a composite material having one or more fillers in a support material (aforementioned silicone/elastomer), which are used in particular to increase the heat conductivity and/or the specific heat capacity while maintaining the mechanical strength. The second material can further be ferromagnetic, wherein this property can also be used for positioning and adhesion to the support. In this case, the tool can have a magnet (for example, a permanent magnet or an electromagnet) to hold the bar in the support or at least facilitate its adhesion.

One or more of the aforementioned fillers can be present in particle form and mixed into the support material in this form. The mechanical strength can then be achieved, for example, by a spherical shape of the particles and a corresponding particle size between 1-10 μm of the fillers. Materials considered for a filler are preferably aluminum, copper, an aluminum alloy, a copper alloy, brass, bronze, Amcorloy, one iron oxide, iron, pure iron, or steel. Furthermore, peroxide crosslinking, platinum-containing crosslinkers, general crosslinkers, inhibitors, catalysts and stabilizers can, inter alia, be used for appropriate crosslinking. Preferably, this maximizes the material content of the filler to accordingly maximize heat conduction or at least optimize it by considering a material strength or an abrasion resistance to be achieved. In such and other embodiments, heat input and pressure transfer can thus be adapted to the film and/or the material of the target object in the area of a seal.

In the present invention, the support of the first material not only provides mechanical stability but also carries the required heat to the area of the bar that is curved outwards. This area can therefore be pressed onto a film and an area of the target object (for example the rim of a pot, see below for details in connection with FIG. 5), wherein the required heat is supplied to the sealing area. The curvature to the outside (crowning) preferably enables an initial linear contact. As the tool is advanced further onto the film, the outwardly curved area of the bar is pressed onto the film, wherein the mechanical contact area progressively increases in both directions away from the initial line. This advantageously allows to achieve a pressing out or pressing away of, for example, any impurities on the film or on the sealing rim of the target object. As a result, it can be ensured also in the area of critical packaging (hygiene-critical packaging such as in the area of food packaging) that impurities or residues of the goods to be filled adversely affect the adhesion or bond of the film to the target object.

FIG. 1B shows a schematic top view of the tool from FIG. 1A. In this embodiment, the bar 21 is configured ring-shaped or circular, wherein at least the curved area of the bar 21 is visible in top view. The support 11 is arranged in at least one area below the bar 21, but can also extend into an area outside and/or inside the bar. Depending on the intended purpose, an inner radius of, for example, 60 mm, 68 mm or 86 mm is possible for a circular bar, with a bar width D in a range from 3 to 6 mm. In a preferred embodiment, the bar width D is increased by 0.5 to 1.0 mm relative to a sealing edge of the target object (for example, a pot).

FIGS. 2A to 2D show schematic sectional views of tools according to further embodiments of the present invention, wherein the realization of the bar 21 should, in particular, be described. FIG. 2A shows an embodiment in which the support 11 has a groove 111 into which the bar in the form of a profiled O-ring 22 can be inserted and fitted. In the embodiment shown, the groove 111 follows a substantially rectangular profile and thus establishes a relatively large contact area with the O-ring, which in turn establishes an advantageously high heat transfer to the O-ring and finally to the curved surface W.

FIG. 2B shows one embodiment in which the support 11 has a groove 112 into which the bar in the form of a profiled O-ring 23 can be inserted and fitted. In the embodiment shown, the groove 112 follows a profile essentially adapted to the profile of the O-ring 23 and constitutes, with an undercut, an advantageous attachment of the O-ring. In this embodiment, an optimization of the contact area on the one hand and the avoidance of load and force peaks on the other hand can advantageously be established. Even though the contact area available to the O-ring 23 for heat transfer from the support 11 is slightly reduced compared to other embodiments, the rounded basic shape achieves a more uniform and improved force transmission. This can significantly increase the service life and reliability of the tool.

The cross-sectional shape of four circular segments also ensures that a corresponding undercut in the groove 112 reliably holds the O-ring 23. While the outer surfaces of the O-ring 23 facing the target object and the support can again be described by a first radius r1 (cf. FIG. 1A), the side surfaces can be described by a second, smaller radius r2. Advantageous embodiments can be achieved with a first radius r1 in a range from 4 mm to 9 mm and a second radius r2 in a range from 1 mm to 3 mm. In these embodiments, an air space or formation thereof in an area where the O-ring contacts the groove can be effectively avoided in an advantageous manner. This allows to achieve good heat transfer, and the occurrence of peak loads at the corners and/or squashings can also be avoided. While the avoidance of the load peaks or squashings can increase the service life of the O-ring, increased or optimal heat transfer can also result in an overall increased processing speed with the tool.

FIG. 2C shows one embodiment in which the support 11 has a base bar 112 to which the bar is applied in the form of a coating 24 of aforementioned second material. The corresponding connection can be established in a releasable or non-releasable manner, wherein the surfaces of the base bar 112 are pretreated with corresponding, but per se known, methods before the coating 24 to realize the bar of aforesaid second material is made.

FIG. 2D shows one embodiment in which the support 11 has a base bar 113 to which the bar is applied in the form of a coating 25 of aforementioned second material. In this embodiment, the base bar has an upper profile Z which is located below the curved area W of the bar. The profile Z can respectively have rounded elevations on the outside and a rounded recess in the middle, and thus correspond to something like a tooth profile. This profile can advantageously distribute the force as desired when the tool is pressed onto a film and a target object, thus allowing an optimum sealing process to take place. The corresponding connection between the base bar and the coating can again be established in a releasable or non-releasable manner, wherein at least also parts of the surfaces of the base bar 113 are again pretreated with corresponding, but per se known, methods before the coating 25 to realize the bar of aforementioned second material is made.

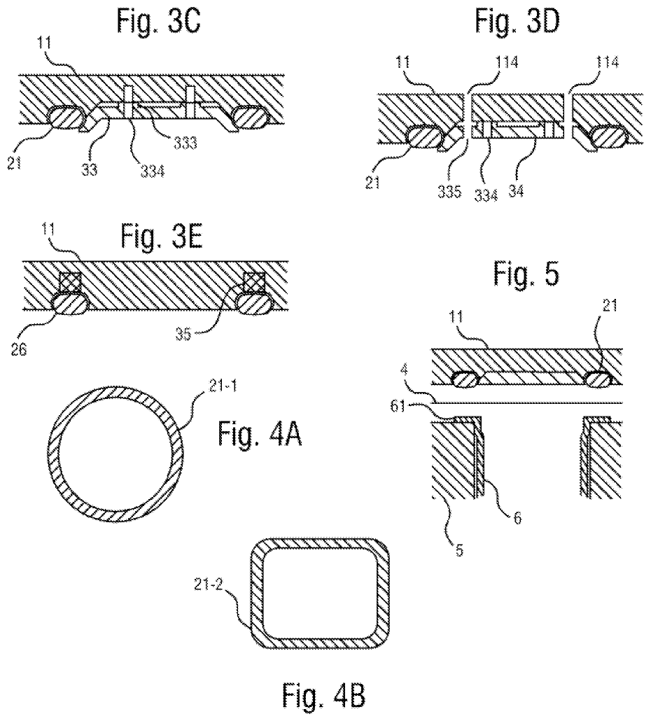

FIGS. 3A to 3E show schematic sectional views of tools according to further embodiments of the present invention, in which the tool further comprises an inner support of a third material. This third material can be the same as aforementioned first material, or any of the following materials, or any combination of more than one of the following materials: Machinable ceramics, ceramics, glass fiber reinforced ceramics, glass fiber reinforced plastics (GFRP), high temperature resistant and/or foamed synthetic materials, foamed silicates (aerogels), foam glass, and any other thermally and mechanically resistant insulating material. Moreover, the third material and/or the inner support can be provided at least partially with a coating for achieving food compliance. Further preferably, the third material has a continuous service temperature of at least 250° C.

FIG. 3A schematically shows the tool according to one embodiment with the inner support. The tool thus comprises the inner support 31 of the third material. In this embodiment, the undercut of the groove continues in the support 11, and thus the bar in the form of an O-ring 21 can continue to be held in a tension-free and reliable manner.

FIG. 3B schematically shows the tool according to a further embodiment with the inner support. The tool thus comprises the inner support 32 of the third material. Also in this embodiment, the undercut of the groove is continued in the support 11, and therefore the bar in the form of an O-ring 21 can continue to be held in a tension-free and reliable manner. Furthermore, the inner support 32 continues outwardly by a distance d, or protrudes by the distance d, beyond the end of the curvature W of the bar. The magnitude of d can advantageously be selected in a range between 100 μm and 600 μm or in a range between 200 μm and 400 μm. An advantageous effect of this protruding portion of the inner support 32 can include further pressing and/or straightening of the film on the target object.

Moreover, at least in this embodiment, the inner support 32 includes a central recess 321 which advantageously provides space for the film to expand during application. Further advantageously, warping or other adverse changes in the film can thus be avoided. This can be particularly important if the film has an imprint that is not to be changed or only imperceptibly changed by the application. Moreover, the central recess 321 allows the film to expand upwards when the film inflates, for example as the lid of a pot packaging.

FIG. 3C schematically shows the tool according to a further embodiment with the inner support. The tool thus comprises the inner support 33 of the third material. A distance as well as a central recess are also provided in this embodiment, but additionally also a spacing from the support 11 by spacer crowns 333. These areas 333 can at the same time serve as a guide part for releasable fastening means (bolts, screws, press or plug connections, snap hooks, undercut, etc.). Together with the properties of the third material, spacing allows to reduce heat input in a central area. This can advantageously protect the film during application in this area and effectively prevent warping, fusing or other adverse changes.

FIG. 3D schematically shows the tool according to a further embodiment with the inner support. The tool thus comprises the inner support 34 of the third material. A distance, a central recess and a spacing from the support 11 are also provided in this embodiment. In addition, ventilation channels 335 are provided in both the inner support 34 and the support 11, which can aerate and de-aerate the area of the inner recess (cf. reference number 321 in FIG. 3B) to the outside. Thus, the film can advantageously expand unhindered into the central recess during application and, in addition, the film does not adhere to the tool due to negative pressure during removal.

FIG. 3E schematically shows the tool according to a further embodiment with the inner support. Thus, the tool at least comprises one recessed or fitted magnet 35 in the support 11, which can hold a bar 26 having ferromagnetic properties or which at least facilitates an adhesion of the bar 26. The ferromagnetic property of the bar 26 can be achieved, for example, by using appropriate fillers (as listed above). The magnet 35 can be configured integrally and substantially follow the shape of the bar 26, or a plurality of individual magnets 35 can be provided. A magnet 35 can be a permanent magnet or an electromagnet. Moreover, a magnet 35 can also be defined as a magnetic area generated by accordingly conducted electric circulating currents.

Various features of the corresponding inner supports 31 to 34 have been described in connection with FIGS. 3A to 3E. Further advantageous embodiments of the present invention include other useful combinations which are not explicitly shown due to the need for brevity. However, these further embodiments include at least any combination of the features of the distance d, the central recess 321, the spacing 333, and the ventilation channels 335.

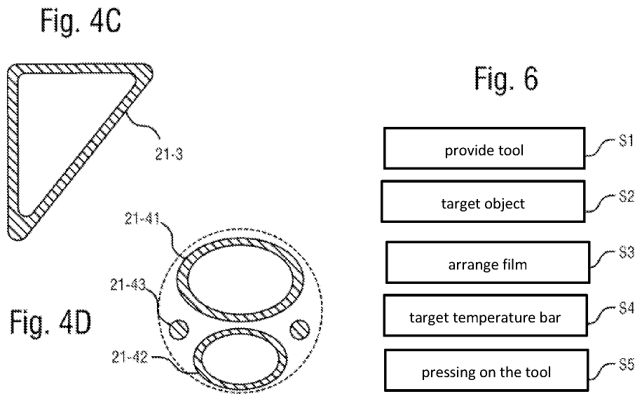

FIGS. 4A to 4D show schematic top views of possible courses of bars in tools according to further embodiments of the present invention. FIG. 4A schematically shows a round or circular course of a bar 21-1 and FIG. 4B a rectangular course of a bar 21-2. It is clear that the embodiments of the present invention are not limited to pure geometric shapes, but also include arbitrary shapes and courses which are due in particular to the characteristics of the target object. Thus, FIG. 4C schematically shows a triangular course of a bar 21-3, which is representative of a generally n-cornered course. In all of these embodiments, the corners can be rounded and/or have further chamfered or rounded entries.

FIG. 4D shows a schematic top view according to another embodiment of the present invention, in which the tool has a plurality of bars 21-41, 21-42 and 21-43 within an area for a single target object (cf. dashed line) or also for several target objects at the same time. Thus, the bars 21-41 and 21-42 follow, for example, any corresponding shape, wherein the third bar 21-43 no longer has a central opening and is shrunk to a punctiform area. Here, the film can be applied onto the target object in a punctiform manner, and the bar 21-43 can be formed by a lens of the second material.

FIG. 5 schematically shows a use of the tool when applying a film onto a target object according to one embodiment of the present invention. As shown, a tool 11 is supposed to apply a film 4 onto a target object 6 under the action of heat and pressure. For this purpose, the target object (for example, a container for a food product such as a yogurt pot) is inserted into a holder 5. A rim 61 of the pot 6 rests on this holder 5, and the film 4 can thus be pressed onto the rim 61 using the tool 11. For this purpose, the bar 21 of the tool 11 is brought to or maintained at a target temperature and moved to the edge 61 under a well-defined or controlled pressure.

In the course of this, the film 4 is applied onto the target object in the area of the rim 61 by pressing, welding and/or otherwise joining the materials of the film 4 and the rim 61.

FIG. 6 schematically shows a flow chart of a method embodiment of the present invention. The corresponding method is used for applying a film onto a target object under the action of heat and/or pressure, and comprises first a step S1 of providing a tool comprising a support of a first material and a bar of a second, elastic material, wherein the bar is arranged on the support, and wherein the bar has at least one area that is curved outwards. Any other tool according to any of the described or encompassed embodiments of the present invention can also be used to carry out the method according to the invention. The method further comprises a step S2 of placing the target object in a holder and a step S3 of providing and arranging the film between the target object and the tool.

In a step S4 of achieving a target temperature on the bar of the tool, the support and/or other parts of the tool are heated, preferably in a controlled or regulated manner, and therefore a desired target temperature is adjusted on or in the bar. The curved area of the bar thus has a desired temperature (for example in a range from 130° C. to 230° C.), and therefore the film can be welded onto the target object upon contact with the film. In a step S5 of a controlled approaching and pressing of the tool onto at least one part of the target object, the film is then joined at least to this part or welded to it under the action of pressure and heat.

In the above context, a method according to the invention was described with steps S1 to S5 in this order. It goes without saying that further embodiments can comprise these steps in a different and/or simultaneous order. Thus, it is only necessary that steps S1 to S4 take place before step S5, wherein moreover step S4 can generally be performed simultaneously within the meaning of a temperature control, continuously and simultaneously with the other steps.

Although detailed embodiments of the invention have now been described, these should only serve for a better understanding of the invention and its effects. The scope of protection is defined by the following claims and should not be limited by the detailed description.

1. Tool for applying a film onto a target object under the action of heat and/or pressure, comprising a support of a first material and a bar of a second, elastic material, wherein the bar is arranged on the support and the bar has at least one area which is curved outwards.

2. Tool according to claim 1, wherein the bar is arranged closed along a circumference, preferably annular or circular, on the support.

3. Tool according to claim 1 or 2, wherein the support comprises a base bar to which the bar is applied in the form of a coating.

4. Tool according to claim 1 or 2, wherein the support comprises a groove that is closed along the circumference, and the bar is arranged in the groove in the form of an O-ring.

5. Tool according to claim 4, further comprising an inner support of a third material, which forms a portion of the groove along its outer periphery.

6. Tool according to claim 4 or 5, wherein the groove has an undercut.

7. Tool according to one of claims 1 to 6, wherein the outwardly curved area of the bar has an outer periphery that is larger than an outer periphery of an area of the target object onto which the film is applied.

8. Tool according to one of claims 1 to 7, wherein the support comprises a recess for receiving a crowning of the film.

9. Tool according to one of claims 1 to 8, wherein the second, elastic material has a ferromagnetic property, and the tool comprises a magnet to hold the bar or facilitate its adhesion.

10. Method of applying a film onto a target object under the action of heat and/or pressure, comprising the steps of
providing a tool comprising a support of a first material and a bar of a second, elastic material, wherein the bar is arranged on the support, and wherein the bar comprises at least one area that is outwardly curved,
inserting the target object into a holder,
providing and arranging the film between the target object and the tool,
achieving a target temperature on the bar of the tool, and
a controlled approaching and pressing of the tool onto at least a part of the target object so that the film is joined to at least this part.

11. The method according to claim 10, wherein providing a tool comprises providing a tool according to one of claims 1 to 9.
